(19) United States
(12) Patent Application Publication
(10) Pub. No.: US 2007/0065702 A1
(43) Pub. Date: Mar. 22, 2007

(54) Fuel cell with anisotropic wetting surfaces

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/229,080

(22) Filed: Sep. 16, 2005

(51) Int. Cl. H01M 8/02; B05D 5/12

(52) U.S. Cl. 429/34; 427/115

(57) ABSTRACT

A fuel cell with components having durable anisotropic wetting surfaces at selected locations where condensation of water may occur. The anisotropic wetting surface generally includes a substrate portion with a multiplicity of projecting microscale or nanoscale asperities disposed on the surface. Each asperity has a first asperity rise angle and a second asperity rise angle relative to the substrate. The asperities are structured to meet a desired retentive force ratio (f₁/f₂) caused by asymmetry between the first asperity rise angle and the second asperity rise angle according to the formula: f₁/f₂=sin(ω₁+1/2Δθ₀)/sin(ω₂+1/2Δθ₀), Δθ₀=(θ_{a,0}−θ_{r,0}).

### FIELD OF THE INVENTION

This invention relates generally to fuel cells, and more specifically to water management in fuel cells.

### BACKGROUND OF THE INVENTION

Fuel cell technology has been the subject of much recent research and development activity due to the environmental and long-term fuel supply concerns associated with fossil fuel burning engines and burners. Fuel cell technology generally promises a cleaner source of energy that is sufficiently compact and lightweight to enable use in vehicles. In addition, fuel cells may be located close to the point of energy use in stationary applications so as to greatly reduce the inefficiency associated with energy transmission over long distances.

Although many different fuels and materials may be used for fuel cells, all fuel cells generally have an anode and an opposing cathode separated by electrolyte. The anode and cathode are generally porous so that fuel may be introduced into the cell through one of them, generally the cathode, and oxidant introduced through the other, generally the anode. The fuel oxidizes in the cell, producing direct current electricity with water and heat as by-products. Each cell generally produces an electrical potential of about one volt, but any number of cells may be connected in series and separated by separator plates in order to produce a fuel cell stack providing any desired value of electrical potential. In modern fuel cell design, the anode, cathode, and electrolyte are often combined in a membrane electrode assembly, and the separator plates and current collectors are often combined in a “bipolar plate.” Details of fuel cell design and operation are further explained in “Fuel Cell Handbook, 5^{th} Edition”, published by the U.S. Department of Energy, National Energy Technology Laboratory, Morgantown, West Virginia, October, 2000, hereby incorporated fully herein by reference. Various fuel cell components, including membrane electrode assemblies and bipolar plates, are further described in U.S. Pat. Nos. 4,988,583; 5,733,678; 5,798,188; 5,858,569; 6,071,635; 6,251,308; 6,436,568; and U.S. Published Patent Application Serial No. 2002/0155333, each of which is hereby fully incorporated herein by reference.

A persistent challenge in the design of fuel cells is that of managing water in the cell. Fuel cells produce water as a reaction product. Under some conditions, water is evolved very quickly within the cell. This water is generally produced on the cathode side of the cell, and if allowed to accumulate, may restrict or block the flow of fuel into the cell. Such a condition is known in the art as “cathode flooding”. In addition, the temperature differences between the cell and ambient environment may be large so that condensation of water vapor may be caused at times as air moves in and out of the cell during operation.

Typically, the surface of bipolar plates is provided with drainage channels so that water is directed through the channels to a collection area to be drained from the cell. In addition, the bipolar plates are often made from material having relatively low surface energy so water drains from the bipolar plate more easily. Neither of these measures has been entirely successful in eliminating cathode flooding and water management problems in fuel cells, however. In particular, even where low surface energy materials such as PTFE are used in fuel cells, water droplets may cling to bi-polar plates and other surfaces in the cell rather than draining away as desired. What is needed in the industry is a fuel cell with components facilitating improved water drainage within the cell.

### SUMMARY OF THE INVENTION

The invention substantially satisfies the aforementioned need of the industry. The invention includes a fuel cell stack apparatus with components having directionally biased wetting surfaces, also referred to as anisotropic wetting surfaces, at selected locations where condensation of water may occur so as to improve water drainage within the apparatus. The anisotropic wetting qualities substantially inhibits any tendency of water droplets to flow in undesired directions, thereby significantly improving water drainage within the cell.

The creation of asymmetric asperities can directionally bias the retentiveness of a surface. This approach can be applied to flat surfaces as well as curved surfaces such as tubes or troughs. Directionally biased fluid retention can be incorporated into conventionally wetting surfaces as well as ultraphobic surfaces. The asymmetric features can be random or periodic in design. Periodic asperities may vary in two dimensions such as structured stripes, ridges, troughs or furrows. Periodic asperities may also vary in three dimensions such as posts, pyramids, cones or holes. The size, shape, spacing and angles of the asperities can be tailored to achieve a desired anisotropic wetting behavior.

Generally, anisotropic wetting qualities are effective with droplets on surfaces and slugs ithin tubes, troughs or channels. Surfaces having anisotropic wetting qualities can be used to nsure that small droplets of liquid drain fully from the surface or, alternately, can be used to elp ensure that droplets are retained so that there is less risk of dripping into an undesired location.

The asperities may be formed in or on the substrate material itself or in one or more layers of material disposed on the surface of the substrate. The asperities may be any regularly or irregularly shaped three dimensional solid or cavity and may be disposed in any regular geometric pattern.

Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities.

Smaller scale asperities may be formed using photolithography, or using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of carbon nanotubes on the substrate.

The invention is a fluid handling device having a normophobic or ultraphobic surface that has anisotropic wetting qualities. That is, fluids will demonstrate a variable resistance to flow across the surface depending on the direction in which they flow. The anisotropic wetting surface generally includes a substrate portion with a multiplicity of projecting asymmetrical regularly shaped microscale or nanoscale asperities.

The asperities may be formed in or on the substrate material itself or in one or more layers of material disposed on the surface of the substrate. The asperities may be any regularly or irregularly shaped three dimensional solid or cavity and may be disposed in any regular geometric pattern or randomly.

### BRIEF DESCRIPTION OF THE DRAWINGS

FIG. 1 depicts a wetting angle formed where a droplet meets a surface;

FIG. 2 depicts examples of advancing contact angle and receding contact angle;

FIG. 3 depicts a sessile droplet on an incline plane;

FIG. 4 depicts a sessile droplet on a vertical surface;

FIG. 5 depicts a sessile droplet on a rotating platter;

FIG. 6 depicts a sessile droplet anchored to a surface by a retention force;

FIG. 7 depicts a slug within an inclined tube;

FIG. 8 depicts a slug acted on by an isostatic pressure;

FIG. 9 depicts a slug within an inclined tube also being acted on by an isostatic pressure;

FIG. 10 depicts a slug within a tube, an advancing and receding contact angle;

FIG. 11 depicts a sessile droplet on a smooth surface;

FIG. 12 depicts a sessile droplet on a rough surface;

FIG. 13 is a side elevational view of an exemplary symmetrical asperity;

FIG. 14 is a side elevational view of an exemplary symmetrical asperity and an exemplary asymmetrical asperity;

FIG. 15 is a cross sectional view of an exemplary surface with periodic asymmetric asperities that would be expected to demonstrate directionally biased wetting;

FIG. 16 is another cross sectional view of an exemplary surface with periodic asymmetric asperities that would be expected to demonstrate ultraphobic properties and directionally biased wetting;

FIG. 17 is a chart of calculated retentive forces for water slugs in PFA tubes;

FIG. 18 is a graph of retentive force ratio vs. first asperity rise angle for various second asperity rise angles where the difference between advancing contact angle and receding contact angle is fixed at ten degrees;

FIG. 19 is a graph of retentive force ratio vs. first asperity rise angle for various differences between advancing contact angle and receding contact angle where the second asperity rise angle is fixed at ninety degrees

FIG. 20 is a simplified cross-sectional view of a fuel cell stack apparatus with ultraphobic surfaces according to the present invention; and

FIG. 21 is an enlarged partial view of the fuel cell stack apparatus of FIG. 20, depicting one channel in the apparatus.

### DETAILED DESCRIPTION OF THE INVENTION

For the purposes of this application, the term “fuel cell” means any electrochemical fuel cell device or apparatus of any type, including but not limited to proton exchange membrane fuel cells (PEMFC), alkaline fuel cells (AFC), phosphoric acid fuel cells (PAFC), molten carbonate fuel cells (MCFC), and solid oxide fuel cells (SOFC). The term “fuel cell stack apparatus” refers to an apparatus including at least one fuel cell and any and all components thereof, along with any and all of the separate components related to the functioning of the fuel cell, including but not limited to, enclosures, insulation, manifolds, piping, and electrical components.

A portion of an embodiment of a fuel cell stack apparatus 100 according to the present invention is depicted in simplified cross section in FIG. 20. Fuel cell stack apparatus 100 generally includes membrane electrode assemblies 102, which are separated by bipolar plates 104. End plates 106 contain the apparatus 100 at each end. Each membrane electrode assembly 102 generally includes an anode membrane structure 108, a cathode membrane structure 110, and an electrolyte 112.

Bipolar plates 104 and end plates 106 are typically made from electrically conductive, corrosion and heat resistant material such as metal or carbon filled polymer. Surfaces 114 of bipolar plates 104 and the inwardly facing surfaces 116 of end plates 106 typically have channels 118 for conveying fuel and oxidant to membrane electrode assemblies 102 and to drain away water which is a product of the reaction. Heat transfer portions 120 of bipolar plates 104 and end plates 106 may provide additional surface area to remove heat from the cells.

According to the invention, all or any desired portions of the outer surfaces of bipolar plates 104 or end plates 106 may be anisotropic wetting surfaces. As depicted in FIG. 21 for example, anisotropic wetting surfaces 20 may be provided on the inwardly facing surfaces 121 of channels 118 to improve water drainage in the channels 118. Water droplets evolved during the reaction process will flow more easily in a desired direction on the anisotropic wetting surfaces 20, causing the water to drain from the channels 118 by gravity.

As depicted in FIG. 20, other portions of the bipolar plates 104 or end plates 106, such as heat transfer portions 120 and outer surfaces 122, may also be provided with anisotropic wetting surfaces 20 to improve drainage of water collecting or condensing on these surfaces. Other components of the fuel cell stack assembly, such as fuel and oxidant manifolds and piping (not depicted), vents (not depicted), and enclosure surfaces (not depicted) may be provided with anisotropic wetting surfaces 20 to drain water that may condense on these components due to the movement of humid gases between the ambient environment and the elevated temperatures within the cell. It will be readily appreciated that an anisotropic wetting surface 20 according to the invention may be provided on any desired portion of any fuel cell stack apparatus component in order to improve the water drainage characteristics thereof.

An enlarged view of exemplary directionally biased wetting surfaces 30 is depicted in FIGS. 15 and 16. A directionally biased wetting surface 30 generally includes substrate 32 and a multiplicity of projecting asperities 34.

Each asperity 34 in this example protrudes from substrate 32. Asperities 34 may also be indentations into substrate 32.

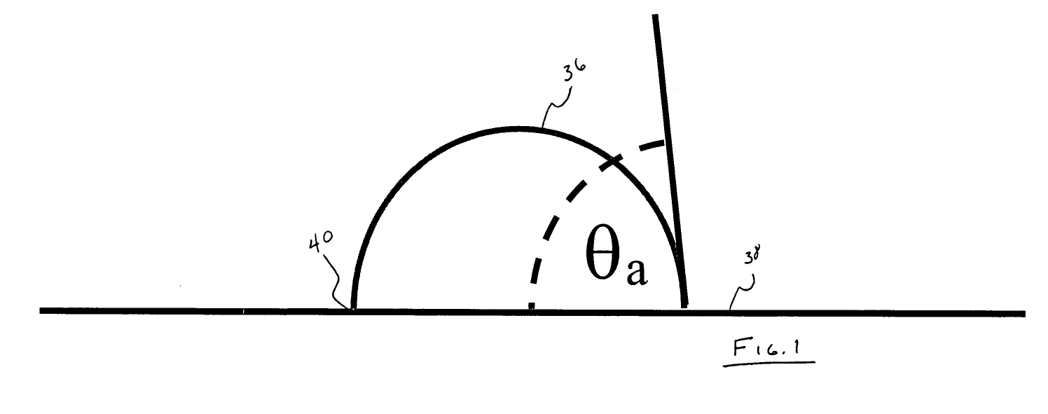

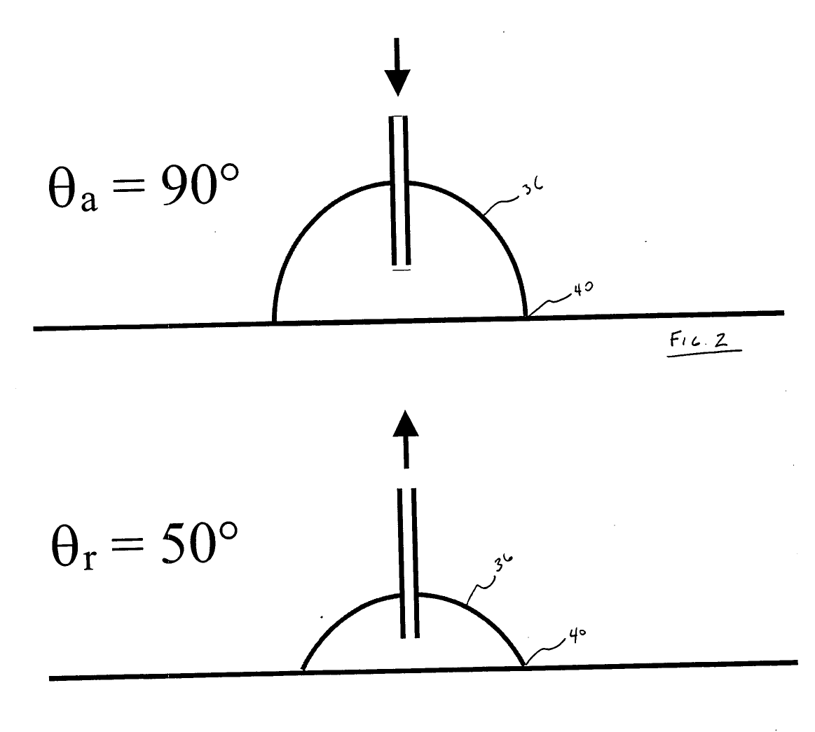

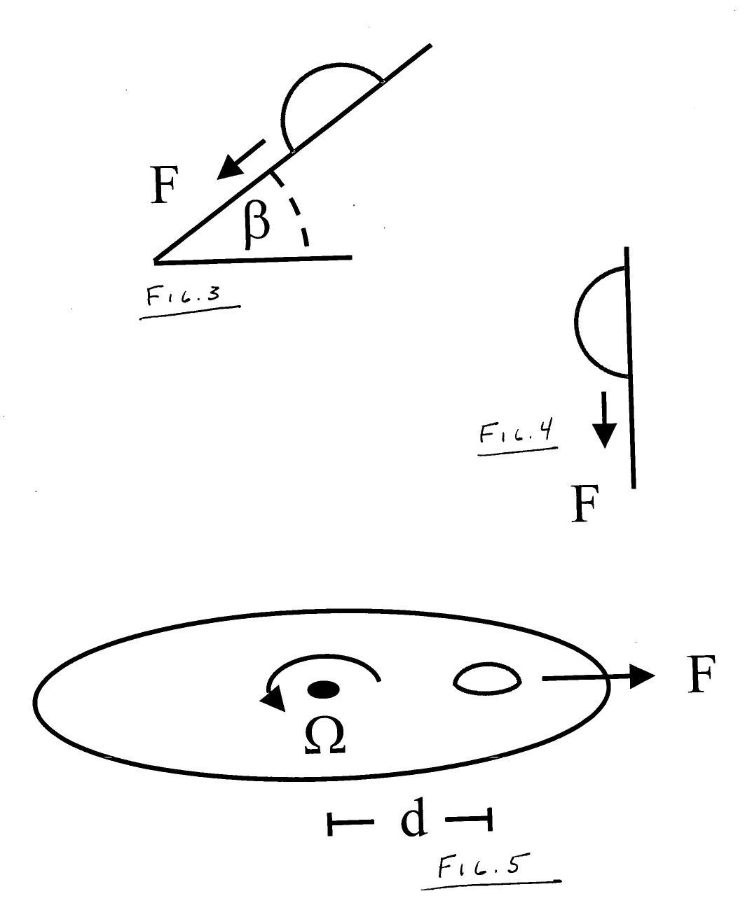

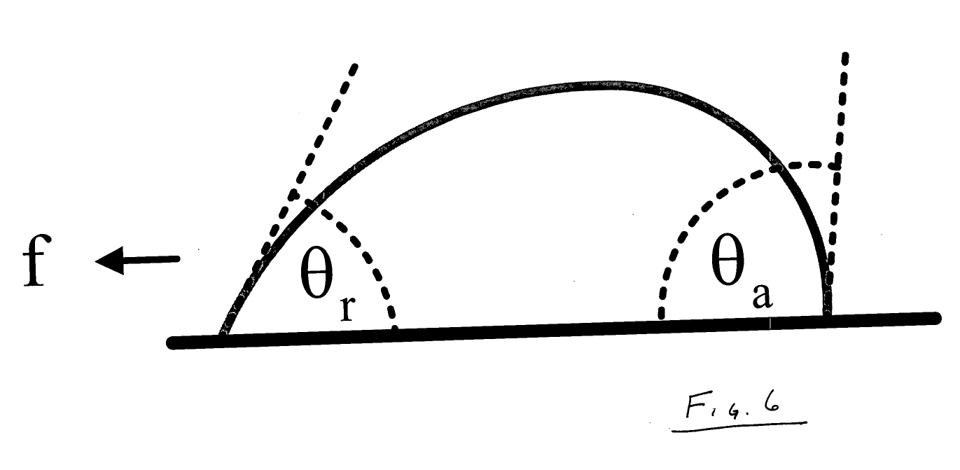

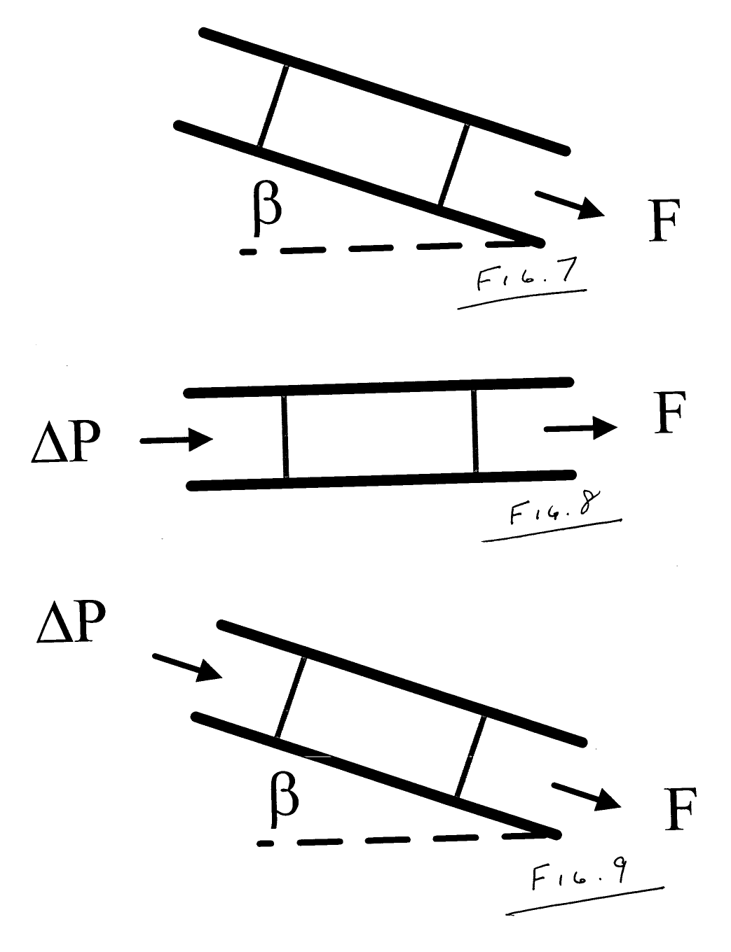

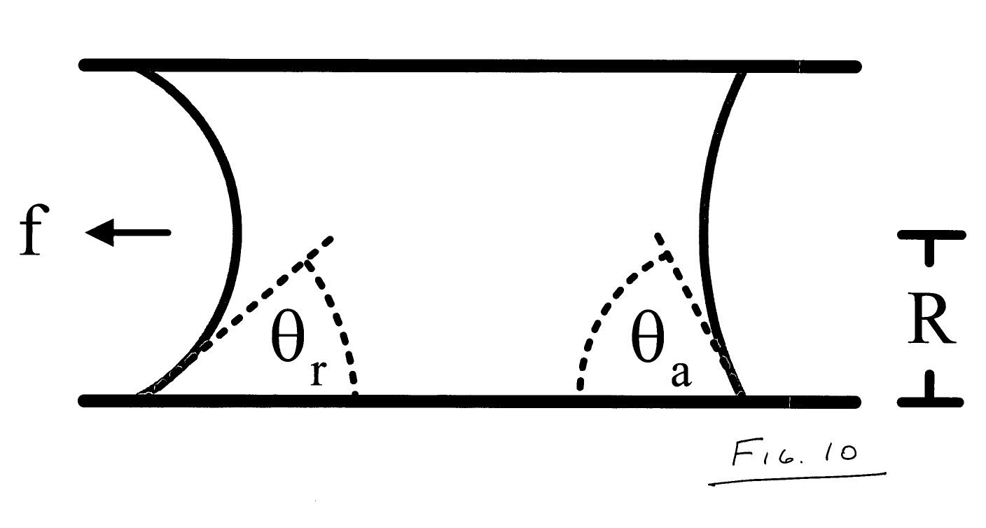

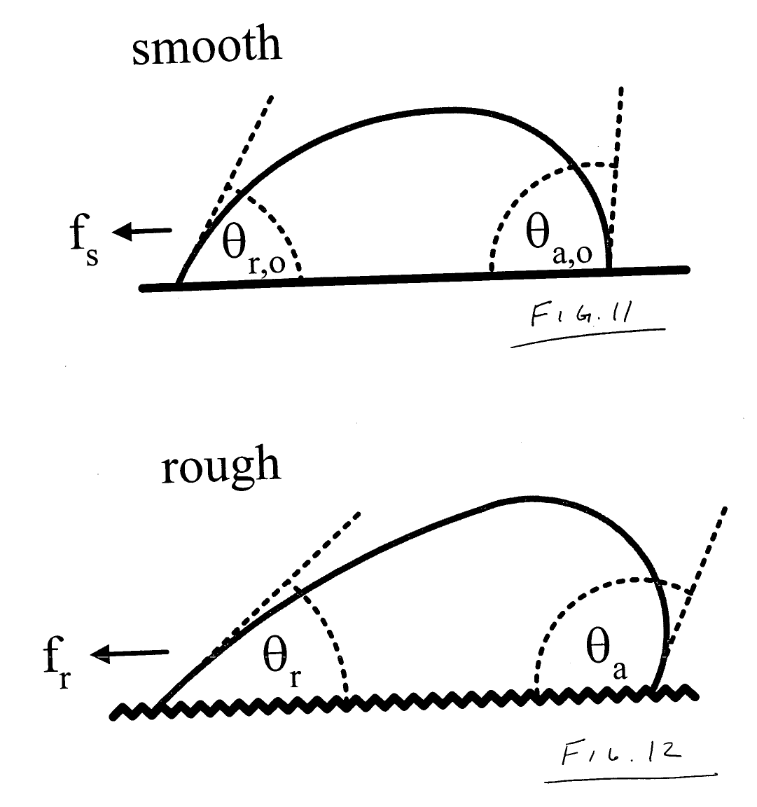

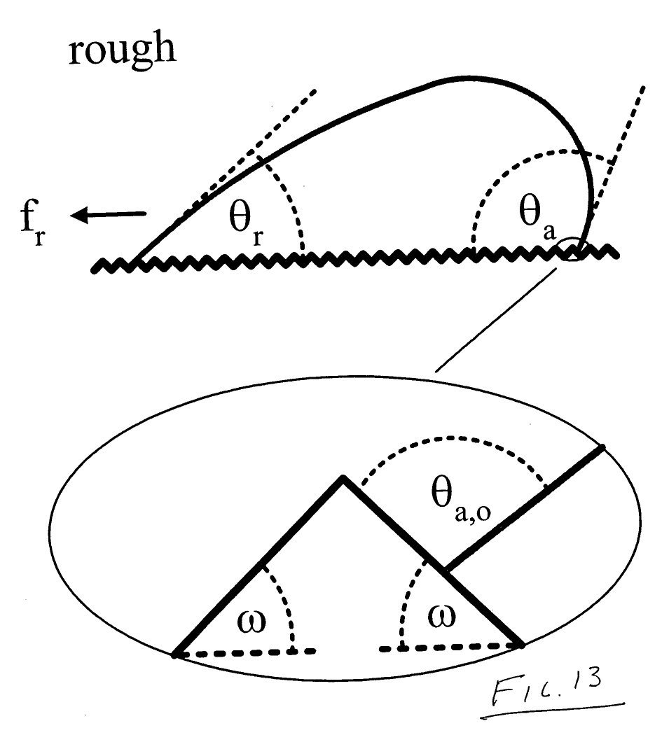

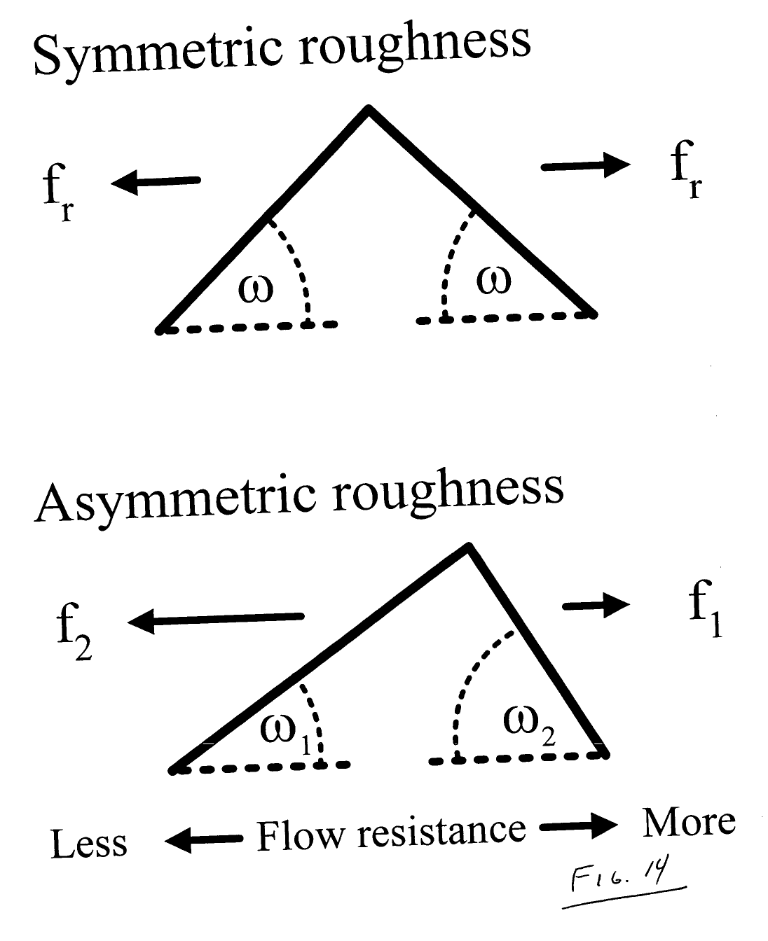

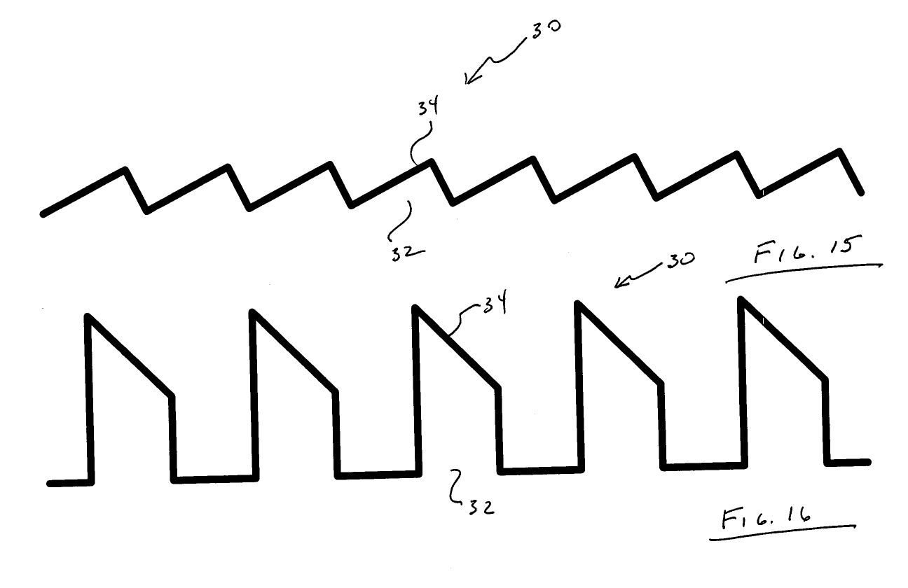

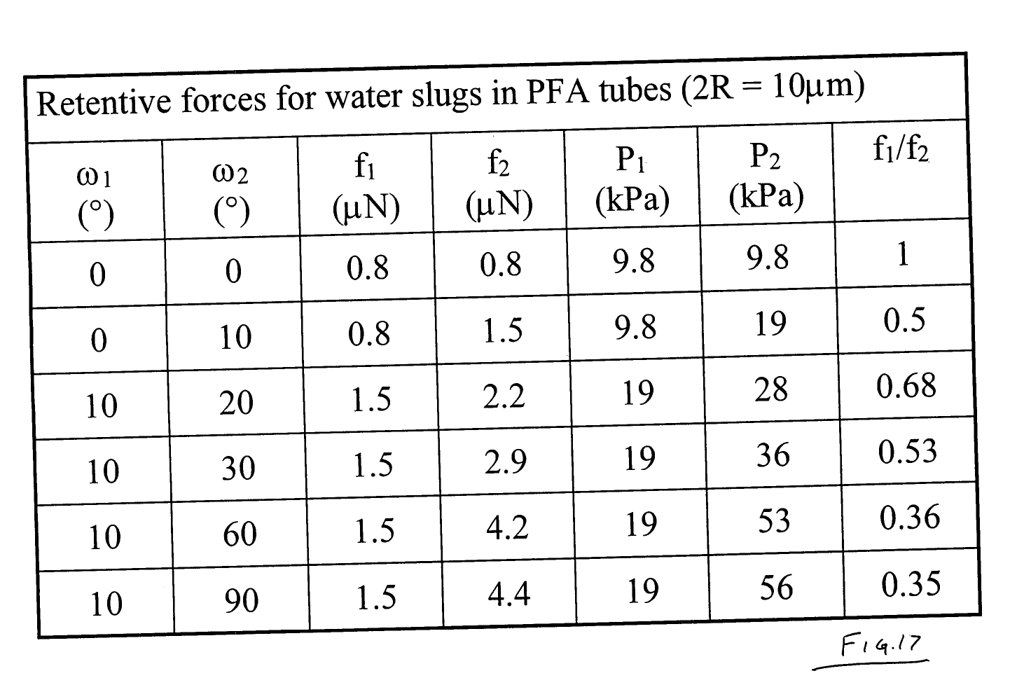

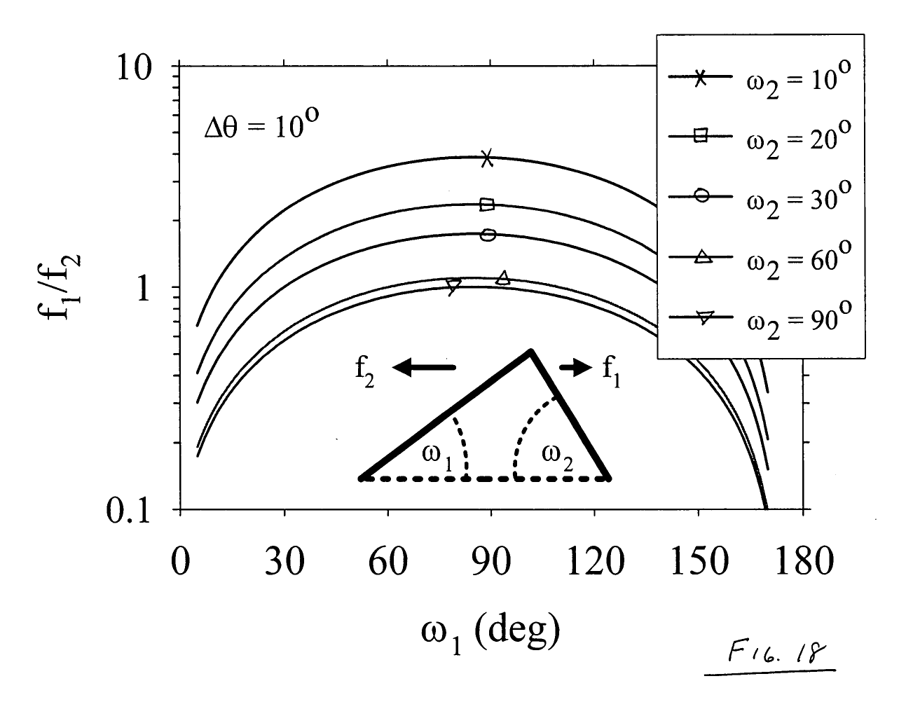

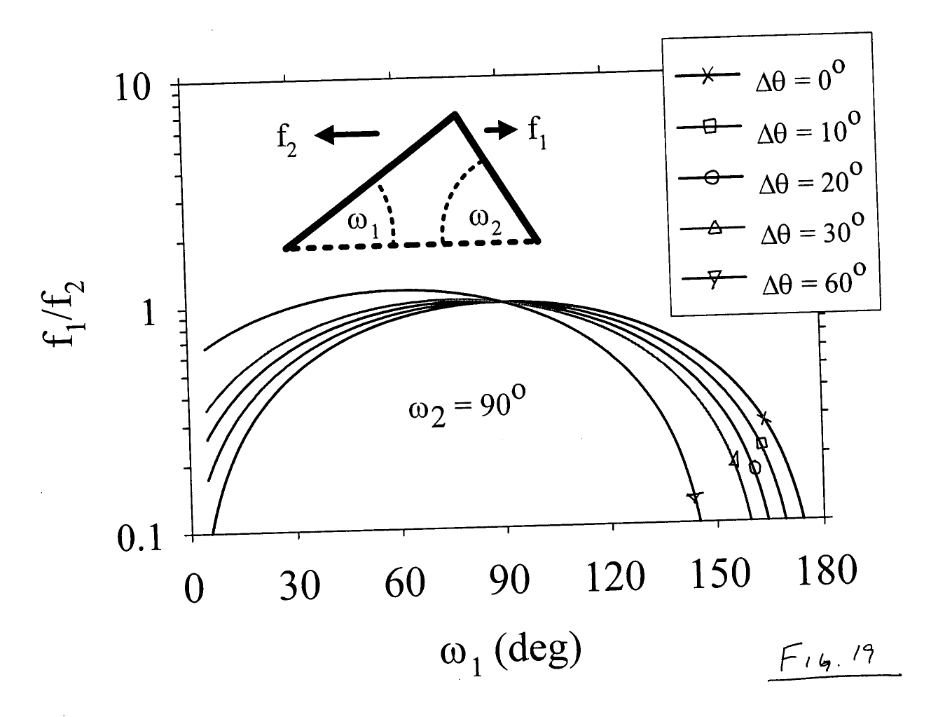

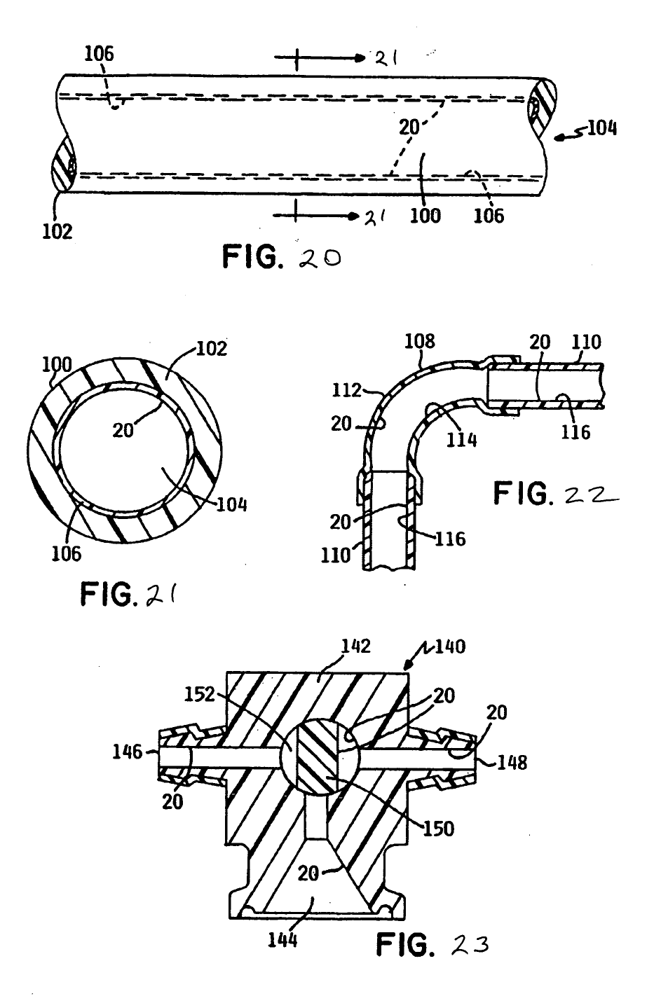

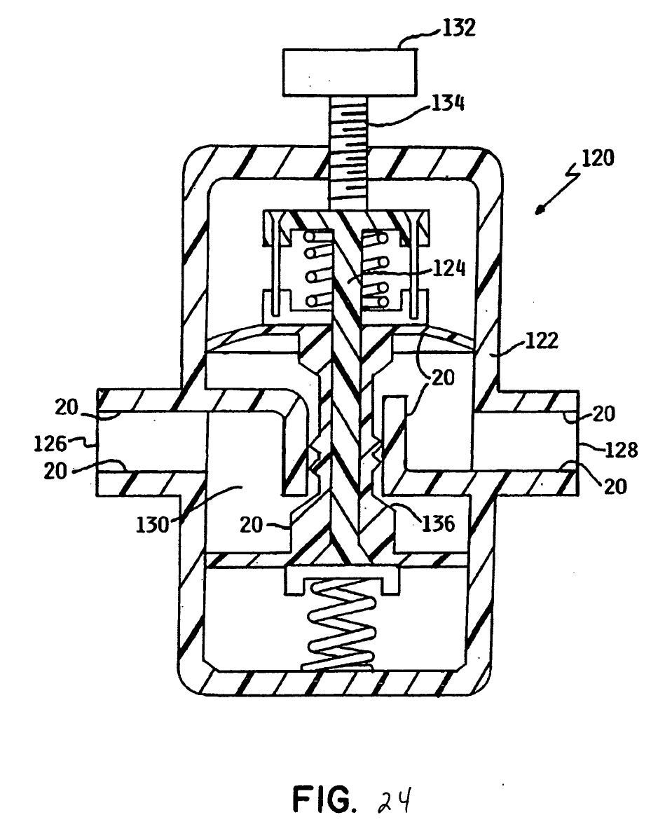

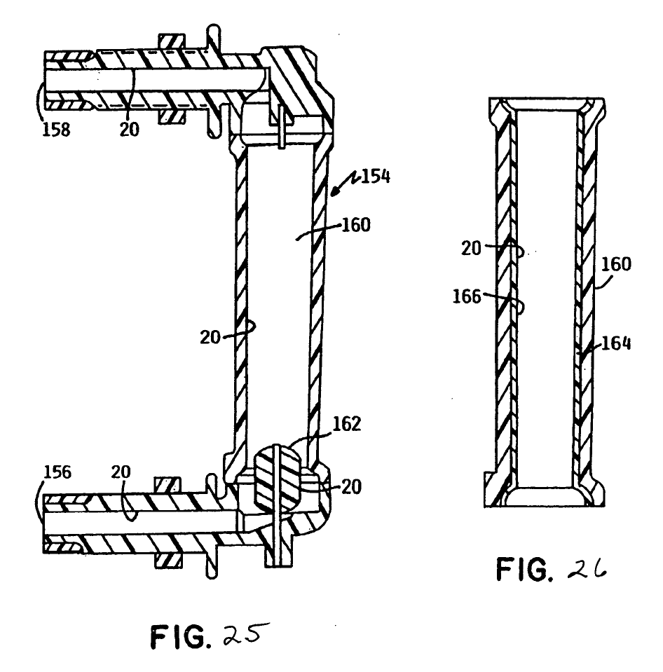

Referring to FIG. 1, a droplet 36 meets a surface 38 at a contact angle annotated θ. Contact angle is affected by hysteresis. When the contact line 40 between the droplet 36 and the surface 38 advances contact angle decreases. Referring to FIG. 2, when an example droplet 36 increases in size because fluid is added, the contact line 40 advances and the advancing contact angle θₐ is equal to about ninety degrees. When the example droplet 36 decreases in size, because fluid is removed, the contact line 40 recedes and the receding contact angle θᵣ equals about fifty degrees. The receding contact angle θᵣ is less than the advancing contact angle θₐ.

Hysteresis can be defined as:
Δθ=θₐ−θᵣ

Hysteresis is caused by molecular interactions, surface impurities, heterogeneities and surface roughness.

In order to better understand the present invention, it is helpful to consider the following cases: Retention of sessile drops by flat surfaces; retention of a liquid slug by a cylindrical tube; and wetted rough surfaces which demonstrate increased liquid-solid adhesion. Wetted rough surfaces include surfaces having symmetric roughness which generally demonstrate isotropic wetting and surfaces demonstrating asymmetric roughness which demonstrate directionally biased wetting.

For Sessile drops, body forces, annotated F, are considered to be the forces acting on the Sessile drops tending to cause it to move along a surface. Body forces may arise from gravity, centrifugal forces, pressure differences or other forces.

Referring to FIG. 3, a sessile droplet is depicted on an incline plane. For this situation body forces are defined by the equation,
F=ρgV·sin β
where
   ρ=density,
   g=the acceleration of gravity,
   V=the volume of the drop, and
   β=the angle of the incline plane.

Referring to FIG. 4, a sessile droplet on vertical surface is depicted. For this situation the acceleration of gravity act parallel to the surface and sin β equals one, so the body force
F=ρgV.

Referring to FIG. 5 for a sessile droplet on a rotating platter
F=ρVΩ²d,
where
   ρ=densitiy,
   V=volume of the drop;
   Ω=angular velocity, and
   d=distance of the droplet from the center of rotation.

Referring to FIG. 6, for sessile drops, retention force, annotated f, anchors the sessile drop in position if the surface forces are greater than body forces. Retention force is defined by the equation:
f=kγR·Δ cos θ,
where
   γ=liquid surface tension,
   2R=drop width,
   k=4/π for circular drops, and
   k>4/π for elliptical drops, and
      Δ cos=(cos θᵣ−cos θₐ).

Referring to FIG. 7, when considering the body forces affecting a cylindrical liquid slug in a tube, for an inclined tube, body forces
F=ρgV·sin α,
where
   ρ=density of the liquid,
   g=the acceleration of gravity,
   V=the volume of the slug, and
   β=angle of inclination.

Referring to FIG. 8, when considering the body forces affecting a cylindrical slug affected by isostatic pressure
F=AΔP=πR²ΔP,
where
   A=area,
   ΔP=differential isostatic pressure,
   R=radius of the cylindrical slug.

Referring to FIG. 9, when a slug is acted on by a combination of isostatic pressure and gravity in an inclined tube
F=ρgV·sin β+πR²ΔP.

Now, referring to FIG. 10, retention force (f) anchors a slug in position if surface forces are greater than body forces.
f=kγR·Δ cos θ,
where
   γ=liquid surface tension,
   R=drop/tube radius,
   k=2π for slugs,
   Δ cos θ=(cos θᵣ−cos θₐ).

To summarize, retention force
f=kγR·Δ cos θ
where
   k=4/π for sessile drops
   k=2π for slugs,
   γ=liquid surface tension,
   R=drops/tube radius,
   Δ cos θ=(cos 74 ᵣ−cos θₐ).
      Now, referring to FIGS. 11 and 12, we consider the effect of surface roughness on adhesion or retention of droplets. As can be seen in FIG. 12, when a droplet is placed on a rough surface, the liquid of the droplet is impaled by the asperities 34 on the surface. Because of the interaction of the asperities 34 with the contact line 40, the advancing contact angle intermittently increases as compared to a flat surface and the receding contact angle intermittently decreases as compared to a flat surface. Thus, the force to move the drops along a rough surface is much greater than for a corresponding smooth surface.

For rough surfaces one can consider the geometric interaction of the droplet with the asperities 34 in the following equations.
θₐ=θ_{a,0}+ω,
θᵣ=θ_{r,0}−ω.

Thus, for smooth surfaces, the retention force
fₛ=kγR(cos θ_{r,0}−cos θ_{a,0}).

For rough surfaces, the retention force
fᵣ=kγR[ cos(θ_{r,0}−ω)−cos(θ_{a,0}+ω)].

Referring to FIG. 13,it is then possible to compare the retentive forces of comparable rough surfaces and smooth surfaces. For example, we will assume a small Sessile water drop on a surface of formed from PFA or PTFE where
k=4/π, γ=72 mN/m,
2R=2 mm,
θ_{a,0}=110°,
θ_{r,0}=90°
and we will consider the variation in roughness (ω). Referring to FIG. 17, it can be seen that retention force fₛ for a smooth surface is substantially less than the retention force fᵣ for rough surfaces. In addition, with increasing values of ω, the retention force increases dramatically.

Thus, symmetric roughness leads to isotropic wetting because the value of fr is equal in symmetric directions.

Referring to FIG. 14, asymmetric roughness can be shown to cause directionally biased wetting. This is also known as anisotropic wetting. Anisotropic wetting occurs because of the difference in retentive force created by asymmetric roughness:
f₁−f₂=kγR[ cos(θ_{r,0}−ω₁)−cos(θ_{a,0}+ω₁)−cos(θ_{r,0}−ω₁)+cos(θ_{a,0}+ω₁)].

Thus, it is possible to calculate a retentive force ratio (f₁/f₂) caused by asymmetric roughness.
f₁/f₂=sin(ω₁+1/2Δθ₀)/sin(ω₂+1/2Δθ₀),
where
   Δθ=(θa,0−θ_{r,0}).

Thus, it is possible to compare the retentive forces on drops caused by asymmetric roughness. For this example we will assume a small sessile water drop on a PFA or PTFE surface. In this case k=4/π, y=72 mN/m, 2R=2 mm, θ_{a,0}=100°, θ_{r,0}=90° and we will vary the values of ω₁ and ω₂. The results of this calculation can be found in a table at FIG. 18.

Referring to FIG. 18, it can be seen that the ratio of f₁/f₂ varies considerable from a smooth surface and for surfaces of various roughnesses.

It is also possible to compare the retentive forces related to slugs in a cylindrical tube. For this example we will assume a small water slug in PFA tube wherein
k=π,
γ=72 mN/m,
2R=10 μm,
θ_{a,0}=100°,
θ_{r,0}=90°.
When we vary the values of ω₁ and ω₂. The results of this calculation can be seen in the table depicted in FIG. 17.

When these results are graphed, referring to FIG. 18, it can be seen that the quotient of f₁ divide by f₂ varies with changes in ω₁ reaching a maximum at about ninety degrees and declining as ω₁ approaches zero and one hundred eighty degrees.

In addition, referring to FIG. 19, results can be seen when Δθ is varied the second asperity rise angle is fixed.

Generally, the substrate material may be any material upon which micro or nano scale asperities may be suitably formed. The asperities may be formed directly in the substrate material itself, or in one or more layers of other material deposited on the substrate material, by photolithography or any of a variety of suitable methods. Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities. Direct extrusion may be used to form asperities in the form of parallel ridges. Such parallel ridges are most desirably oriented transverse to the direction fluid flow. Features in flow channels of bipolar plates according to the invention may be formed with a compression molding tool having microscale asperities built into the molding surfaces for the flow channels.

Other methods that may be suitable for forming smaller scale asperities of the desired shape and spacing include nanomachining as disclosed in U.S. Patent Application Publication No. 2002/00334879, microstamping as disclosed in U.S. Pat. No. 5,725,788, microcontact printing as disclosed in U.S. Pat. No. 5,900,160, self-assembled metal colloid monolayers, as disclosed in U.S. Pat. No. 5,609,907, microstamping as disclosed in U.S. Pat. No. 6,444,254, atomic force microscopy nanomachining as disclosed in U.S. Pat. No. 5,252,835, nanomachining as disclosed in U.S. Pat. No. 6,403,388, sol-gel molding as disclosed in U.S. Pat. No. 6,530,554, self-assembled monolayer directed patterning of surfaces, as disclosed in U.S. Pat. No. 6,518,168, chemical etching as disclosed in U.S. Pat. No. 6,541,389, or sol-gel stamping as disclosed in U.S. Patent Application Publication No. 2003/0047822, all of which are hereby fully incorporated herein by reference. Carbon nanotube structures may also be usable to form the desired asperity geometries. Examples of carbon nanotube structures are disclosed in U.S. Patent Application Publication Nos. 2002/0098135 and 2002/0136683, also hereby fully incorporated herein by reference. Also, suitable asperity structures may be formed using known methods of printing with colloidal inks. A photolithography method that may be suitable for forming micro/nanoscale asperities is disclosed in PCT Patent Application Publication WO 02/084340, hereby fully incorporated herein by reference.

It is anticipated that fuel cell components having anisotropic wetting surfaces will exhibit greatly improved drainability due to the tendency of the surface to facilitate fluid flow in a desired direction, causing them to roll freely by gravity in the direction of surface slope. In addition, it is anticipated that an anisotropic wetting surface according to the present invention may improve heat transfer from the surface due to the increased surface area created by the presence of asperities on the surface.

The present invention may be embodied in other specific forms without departing from the central attributes thereof, therefore, the illustrated embodiments should be considered in all respects as illustrative and not restrictive, reference being made to the appended claims rather than the foregoing description to indicate the scope of the invention.

What is claimed is:

1. A component for a fuel cell stack apparatus comprising:
a body having a surface portion, said surface portion including a substrate having a surface with a multiplicity of asymmetric substantially uniformly shaped asperities thereon, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0}).
where ω₁ is the first asperity rise angle in degrees;
ω₂ is the second asperity rise angle in degrees;
Δθ₀=(θ_{a,0}−θ_{r,0});
θ_{a,0} is the advancing contact angle in degrees; and
θ_{r,0} is the receding contact angle in degrees.

2. The component of claim 1, wherein the asperities are substantially uniformly shaped and dimensioned, wherein the asperities are arranged in a substantially uniform pattern, and wherein the asperities are spaced apart by a substantially uniform spacing dimension.

3. The component of claim 1, wherein said component is a bipolar plate.

4. The component of claim 1, wherein said component is a manifold.

5. The component of claim 1, wherein the asperities are projections.

6. The component of claim 5, wherein the asperities are polyhedrally shaped.

7. The component of claim 5, wherein each asperity has a generally square cross-section.

8. The component of claim 5, wherein the asperities are cylindrical or cylindroidally shaped.

9. The component of claim 1, wherein the asperities are cavities formed in the substrate.

10. A method of making a component for a fuel cell stack apparatus, said component having a surface portion adapted for repelling a liquid, the method comprising steps of:
forming a component body having a surface and a substrate; and
disposing a multiplicity of substantially uniformly shaped asperities on the surface of the substrate, each asperity having a first asperity rise angle and a second asperity rise angle relative to the substrate,
selecting the structure of the asperities to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0}).
where ω₁ is the first asperity rise angle in degrees;
ω₂ is the second asperity rise angle in degrees;
Δθ₀=(θ_{a,01}−θ_{r,0})
θ_{a,0} is the experimentally determined true advancing contact angle in degrees; and
θ_{r,0} is the experimentally determined true receding contact angle in degrees.

11. The method of claim 10, wherein said asperities are substantially uniformly shaped, and wherein the step of disposing the asperities on the surface comprises disposing the asperities in a substantially uniform pattern so that the asperities are spaced apart by a substantially uniform spacing dimension.

12. The method of claim 11, further comprising the step of selecting a geometrical shape for the asperities.

13. The method of claim 11, further comprising the step of selecting an array pattern for the asperities.

14. The method of claim 10, wherein the step of disposing the asperities on the surface including forming the asperities by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of carbon nanotubes on the surface.

15. The method of claim 10, wherein the step of disposing the asperities on the surface including forming the asperities by extrusion.

16. A fuel cell stack apparatus including at least one component having a surface portion adapted for anisotropic wetting, said surface portion including a substrate with a multiplicity of asperities thereon,
each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=sin(ω₁+1/2Δθ₀)/sin(ω₂+1/2Δθ₀), Δθ₀=(θ_{a,0}−θ_{r,0})
where ω₁ is the first asperity rise angle in degrees;
ω₂ is the second asperity rise angle in degrees;
Δθ₀=(θ_{a,0}−θ_{r,0});
θ_{a,0} is the advancing contact angle in degrees; and
θ₀ is the receding contact angle in degrees.

17. The apparatus of claim 16, wherein the asperities are substantially uniformly shaped and dimensioned, wherein the asperities are arranged in a substantially uniform pattern, and wherein the asperities are spaced apart by a substantially uniform spacing dimension.

18. The component of claim 17, wherein said component is a bipolar plate.

19. The apparatus of claim 17, wherein said component is a manifold.

20. The apparatus of claim 17, wherein the asperities are projections.

21. The apparatus of claim 19, wherein the asperities are polyhedrally shaped.

22. The apparatus of claim 19, wherein each asperity has a generally square cross-section.

23. The apparatus of claim 19, wherein the asperities are cylindrical or cylindroidally shaped.

24. The apparatus of claim 16, wherein the asperities are cavities formed in the substrate.
